(19) United States
(12) Patent Application Publication
(10) Pub. No.: US 2013/0122477 A1
(43) Pub. Date: May 16, 2013

(54) Materials Formulations for Human Tissue Simulation

(71) Applicant: Richard K. Everett, Alexandria, VA (US)

(72) Inventor: Richard K. Everett, Alexandria, VA (US)

(21) Appl. No.: 13/727,618

(22) Filed: Dec. 27, 2012

Related U.S. Application Data
(62) Division of application No. 12/480,900, filed on Jun. 9, 2009, now abandoned.

(51) Int. Cl. G09B 23/30

(52) U.S. Cl. CPC G09B 23/30
USPC 434/272; 264/299

(57) ABSTRACT

A gel formulation for use as simulated tissue for ballistic testing includes a mixture of gelatin, a glycol, such as ethylene glycol, and water. The gel may be formed in a mold to simulate a body part, such as an organ. A ratio of gelatin to glycol may be varied, depending on the body part to be simulated. An anatomic model may be formed by incorporating simulated organs formed with different gelatin to glycol ratios.

### BACKGROUND

The present disclosure generally relates to ballistic test media and, more particularly, to simulated tissue formulations that include gelatin and a glycol, such as ethylene glycol.

Wound ballistics is generally the study of the dynamics and impact of projectiles, such as bullets, and projectile forces, such as shock waves, both on intended targets and in alternative situations. Wound ballistics includes a study of a resultant penetrating trauma caused from bullets, shrapnel, knives, or other propelled sharp objects that puncture organs. Wound ballistics also includes a study of the effects of non-penetrating traumas, such as, for example, those resulting from blast injuries, on internal organs. A blast injury, for example, results from an over-pressurization shock wave, generated from a high-order explosive, which moves through the body. Blast injuries are characterized often by lack of a visible, external injury. Rather, gas-containing organs, such as the lungs and bowels, are affected by the shock front of the blast wave and the overpressure. This pulse of increased pressure results in internal contusions and bleeding.

The (gaseous and liquid) fluids that fill organs and cavities in a human body greatly influence, for example, a bullet's or a blast wave's trajectory and energy dissipation (hereinafter referred to as “performance”). Therefore, it is desirable that wound ballistic research materials simulate the properties of human tissue if they are to respond in a similar manner to biological tissue. To ensure that analyses of bullet and blast performance are accurate, the media into which a bullet or a blast wave is tested desirably represents human tissue in its stress and strain characteristics.

Water is a fairly representative medium for testing bullet and blast impact on human subjects because in select situations a bullet or a blast wave can achieve roughly similar performances in both. For this reason, both clay and water-soaked papers are two materials commonly used in ballistic research. However, these materials have several disadvantages: (1) the stress and strain characteristics of these materials are significantly different than live human tissues; (2) consistent use presents challenges to gathering data over time; (3) there is a short time frame for which water based clays can provide more realistic results since clays dry out quickly; and (4) there are many variables, such as, for example, soaking time, and exposure time, and the like, which can affect a density of water-soaked papers.

Because muscle tissue surrounds most bones that protect delicate internal organs, a source of penetrating trauma generally pierces the muscle tissue before it ruptures an internal organ. For this and other reasons, ballistic test media was developed for assessing the source of penetrating trauma's performance and research. This media is an animal-based protein, gelatin (commonly known as “simulated tissue”) that has a density and a consistency comparable to the living muscle tissue it simulates. Existing ballistic gelatin-based formulations are gels which effectively resemble human muscle tissue in these characteristics. Existing gelatin-based gels are typically formed by combining a 20% volume fraction of gelatin with an 80% volume fraction of chilled water. An alteration of the respective volume percentages changes the resultant gel's properties. In general, there is a linear relationship between an amount of dilution of the gelatin and the resulting mechanical properties, such as, for example, elasticity, of the gel.

A problem presented with these existing gels is that they do not provide a capability of studying both penetrating and non-penetrating trauma on the internal organ tissues, which have different densities and mechanical properties than muscle tissue. The density of existing simulated tissues can be adjusted by controlling water content. However, greater water content in diluted gelatin formulations presents several problems: (1) the gel dries out faster and therefore changes properties; and, (2) the gel becomes more susceptible to mold and bacterial growth. The former susceptibility makes it less stable. Highly diluted gelatin formulations also tend to lose their integrity because there are fewer protein strands per unit volume to bind the simulated tissue.

A further shortcoming associated with existing gelatin-based formulations is that they are not stable over time. The gel tends to change its properties within a short period of approximately three days. Furthermore, the gel dries out rather quickly, and a skin forms at its surface. The source of a penetrating trauma, such as, for example, a bullet, penetrates this skin before its performance is fully analyzed. This skin is not representative of human tissue, and it can thus affect an outcome of the ballistic results since it can slow down or alter performance.

There remains a need for a test media formulation that overcomes these problems and others.

### BRIEF DESCRIPTION

A first exemplary embodiment of the present disclosure is directed toward a molded gel formulation for use as simulated tissue comprises at least 2 vol. % gelatin, at least 5 vol. % of a glycol, and water.

A second exemplary embodiment of the present disclosure is directed toward an anatomic model comprising a skeletal component and at least one simulated organ supported on the skeletal component. The simulated organ includes a molded formulation of at least 2 vol. % gelatin, at least 5 vol. % of a glycol, and water. A sensing instrument can optionally be included, either molded into or attached on at least one of the simulated skeletal components, or the simulated organ.

A method of making the simulated human tissue comprises steps of forming a liquid mixture including gelatin, a glycol and water, and then setting the mixture to form a molded gel formulation with a shape which simulates a human tissue.

### BRIEF DESCRIPTION OF THE DRAWINGS

FIG. 1 is a schematic diagram showing a method of producing a formulation of the present disclosure;

FIG. 2 is a chart showing Youngs Modulus (Modulus of Elasticity) for different volume percentages of ballistic gelatin and ethylene glycol;

FIG. 3 illustrates a simulated anatomic model utilizing simulated muscle and organ tissues according to an embodiment of the disclosure;

FIG. 4 is a chart showing stress and strain relationships for various volume percentages of ballistic gelatin and ethylene glycol in an exemplary formulation;

FIG. 5 is a chart showing stress and strain relationships for a human liver, a human small bowel, a simulated liver formed of a gelatin, and a simulated small bowel formed of a gelatin and ethylene glycol-based gel formulation;

FIG. 6 is a chart showing stress and strain relationships for gelatin-based formulations over time;

FIG. 7 is a chart showing stress and strain relationships over time for one embodiment of a formulation including 50% by volume of ballistic gelatin;

FIG. 8 is a chart showing stress and strain relationships over time for another embodiment of a formulation including 40% by volume of ballistic gelatin;

FIG. 9 is a chart showing stress and strain relationships for gelatin formulations after aging in various environments;

FIG. 10 is a chart showing stress and strain relationships after aging in various environments for an exemplary formulation including 50% by volume of ballistic gelatin;

FIG. 11 is a chart showing stress and strain relationships after aging in various environments for an exemplary embodiment including 40% by volume of ballistic gelatin;

FIG. 12 is a chart showing cumulative weight loss over time for ballistic gelatin-based formulations, dependent on various environments;

FIG. 13 is a chart showing cumulative weight changes over time for an exemplary formulation including 50% by volume of ballistic gelatin; and,

FIG. 14 is a chart showing cumulative weight changes over time for an exemplary embodiment including 40% by volume of ballistic gelatin.

### DETAILED DESCRIPTION

The present disclosure is directed toward material formulations for forming simulated human tissues, which can be used for performance analyses of the sources of both penetrating and non-penetrating traumas. In one embodiment, the present disclosure provides a molded gel formulation for simulated inner organ tissues. The molded gel formulation includes gelatin, a glycol, and water. The amounts of gelatin and glycol can be selected to provide a molded gel formulation which resists dehydration while simulating properties of a selected organ.

The term “gelatin,” as used herein, generally refers to unhydrated gelatin, such as gelatin in powder or cake form comprising less than 10 vol. % water. Powdered gelatins are obtainable, for example, from Kind & Knox Co. Such products may have a Bloom number (a measure of the gel strength of gelatin, reflecting the average molecular weight of its constituents) of from 125 Bloom to 300 Bloom; the higher number reflecting a higher gelling power. The highest grade in commerce is around 300 Bloom. The term “ballistic gelatin,” as used herein refers to a hydrated gelatin (a hydrogel), which is obtainable in the form of a gel which may contain at least 50 vol. % water. Ballistic gelatins are obtainable, for example, from Corbin Manufacturing and Supply Company under the tradename SIM-TEST™. The exact composition of the commercially available ballistic gelatin products is not known, but is expected to contain about 10-30% gelatin and the balance predominantly being water, i.e., about 70-90 vol. % water. Either powdered gelatin or ballistic gelatin, or other forms, can be used as raw materials for forming the exemplary gel formulations.

In one embodiment of the disclosure, the molded gel formulation includes gelatin, a glycol, and water. All percentages of ingredients are expressed as volume percentages at room temperature (25° C.), except as otherwise noted.

The gelatin (expressed as unhydrated gelatin, unless specific mention is made of ballistic gelatin) may be present in the formulation at a concentration sufficient to form a gel. For example, the gelatin may be present at a concentration of at least about 2% or at least 4% and in some embodiments, at least 10 vol. % or at least 15 vol. %. In one embodiment, the gelatin is present at up to 90 vol. % of the formulation. In specific embodiments, the gelatin may be present at up to about 30% by volume. In some embodiments, the gelatin may be present at up to about 20% by volume.

The glycol may be present in the formulation at a concentration of at least 5 vol. %. In one embodiment the glycol may be present at a concentration of at last about 10 vol. %. The glycol may be present at up to 90 vol. % In one embodiment, the glycol is present at up to 80 vol. %. In another embodiment, the glycol is present at up to 70 vol. %. In another embodiment, the glycol is present at up to 50 vol. %.

The molded gel formulation may contain at least about 8 vol. % water. In one embodiment, water is present at a concentration of at least about 12 vol. %. water. The water may be present in the formulation at up to about 85 vol. %. In various embodiments, water is present at up to 70% of the formulation. The water may make up the balance of the composition if no other ingredients are present.

The formulation may further include other ingredients, such as preservatives, other alcohols, such as diethylene glycol, crosslinking agents, and other materials used in forming ballistic gelatins. In one embodiment, all other ingredients (other than water, glycol, and gelatin) are present at no more than 10 vol. % of the formulation.

Exemplary crosslinking agents may include, for example, homo-bifunctional crosslinkers, such as N-hydroxysuccinimide (NHS) esters. Examples of NHS-esters include dithiobis(succinimidylpropionate) (DSP) and dithiobis(sulfosuccinimi-dylpropionate) (DTSSP). Other examples of homo-bifunctional reagents include dimethyl adipimidate (DMA), dimethyl suberimidate (DMS), and glutaraldehyde. Other examples of crosslinking agents may include, for example, hetero-bifunctional crosslinkers containing a photoreactive group. Examples of such reagents include succinimidyl 3-(2-pyridyldithio)propionate (SPDP) and succinimidyl trans-4-(maleimidylmethyl)cyclohexane-1-carboxylate (SMCC). Crosslinkers are commercially obtainable from major suppliers, such as, for example, Thermo Fisher Scientific, Inc., Molecular Probes, Inc., and Sigma-Aldrich Co.

For simulating specific organs different gelatin:glycol ratios may be appropriate. The molded gel formulation may contain gelatin (expressed as unhydrated gelatin) and glycol (e.g., ethylene glycol) in a gelatin:glycol ratio, expressed by volume, of at least 0.03:1, e.g., a ratio of at least about 0.1:1, and in one embodiment, of at least 9:1, e.g., of up to about 4:1. The gelatin:glycol ratio may be up to about 4:1, and in one embodiment, the ratio is up to about 2.5:1.

Exemplary glycols suitable for use in the molded gel formulation are those containing 2-7 carbon atoms and two or more hydroxyl groups, such as ethylene glycol, propylene glycol, butylene glycol, pentylene glycol, hexylene glycol, heptylene glycol, glycerol, and combinations thereof. Substituted glycols are also contemplated. The carbons in the molecule can be in the form of a linear alkyl group; a branched alkyl group; a saturated alkyl group; an unsaturated alkyl group; a branched cyclic alkane; a branched cyclic alkene; a substituted chain; an unsubstituted chain, and combinations thereof. In one embodiment, the carbon chain can also contain a heteroatom.

In one embodiment, the glycol has a general formula CH₂(OH)—C(OH)Hₘ—(CH₂)ₙ—(CH₃)ₚ, wherein m is 1 or 2, n is an integer ≧0, and p is 0 or 1. In one embodiment, n≦4. In one embodiment, m=2, n=0, and p=0, such that the glycol is an ethylene glycol. In other embodiments, m=1, n is from 0 to 3, and p=1. In one specific embodiment, at least 80 vol. % of the glycol is ethylene glycol. In another embodiment, the glycol can comprise up to 100 vol. % ethylene glycol.

One embodiment of the present formulation includes from 2% to about 16% by volume gelatin and from about 10% to about 80% by volume glycol. The formulation can further include from about 0% to about 7.5% by volume diethylene glycol. In one embodiment, diethylene glycol is present at a concentration of at least 0.1%.

The exemplary mixture of gelatin, glycol, water, and optionally other ingredients, is selected to form a gel that can serve as a simulated organ tissue that has a density, mechanical properties, and a consistency comparable to the living tissue it simulates.

The concentration of glycol in the formulation may be selected dependent upon the organ the formulation is molded to represent. In one embodiment of the present disclosure, formulations including various combinations of gelatin and glycol may be prepared for simulating different organs. This simulated organ tissue retains its properties for longer periods as compared to existing gelatin-based simulated muscle tissues. The glycol component in the formulation may act as an antimicrobial (e.g. antibacterial) agent to prevent bacterial and mold growth. Glycols can also act as an antiviral agent. The glycol may also provide a hydrophilic behavior which acts as an anti-drying agent for the set formulation.

In practice, there is often a wait period between a time a simulated organ model is cast and a time it is used. There can be significant changes in the mechanical properties of existing simulated tissues during this wait period as well as formation of a skin because water evaporates away from the tissues' surface, thus creating a dry layer. The glycol component of the present formulation, however, acts to absorb, i.e., to pull, water out of the air when present in sufficient relative humidity. Polarization of water molecules in air brings together the hydroxyl ion and the hydrogen ligands. The positive carbon, linked to a hydroxyl on the glycol, attracts the slightly negative oxygen in the water molecules. Hence, the glycol pulls water from air, thus preventing or inhibiting a skin from being formed at the surface of the simulated tissue. Therefore, the present formulation can be considered to be self-stabilizing without the need for additional wraps, skins, barrier layers, or refrigeration.

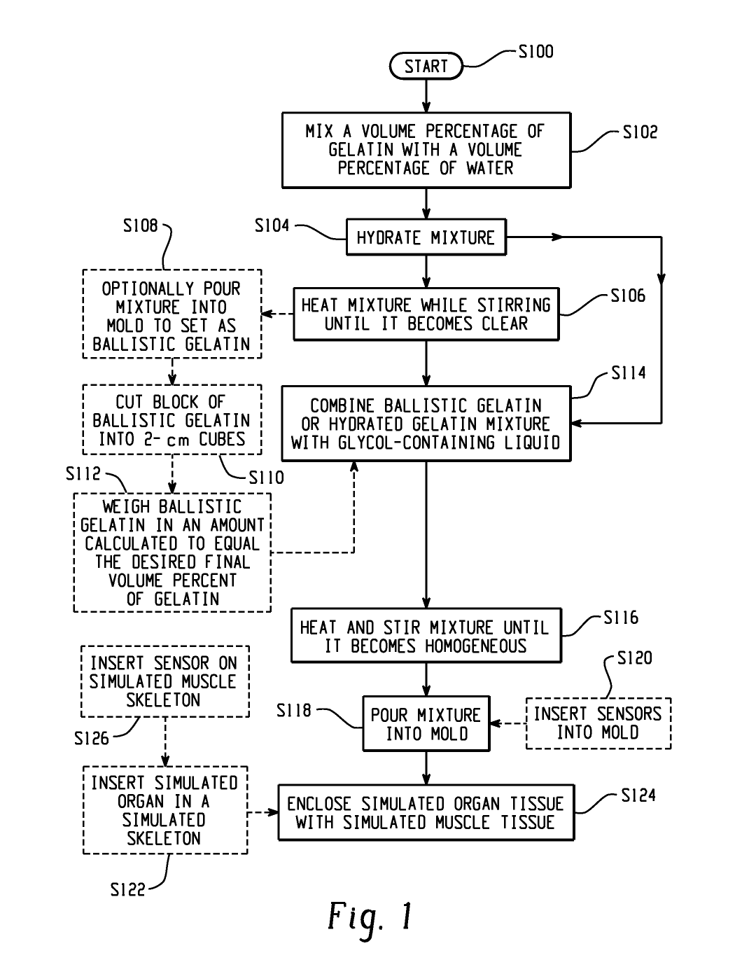

One advantage associated with the present formulation is its preparation time can be comparable to existing methods. As an example, a generalized method of forming a simulated tissue of the present formulation is shown in FIG. 1, and it includes utilization of an unhydrated (e.g., powdered or granulated) gelatin or ballistic gelatin. The method begins at 100. Where a powdered gelatin is used, the method includes mixing a volume percentage of gelatin with a volume percentage of water to form a hydrated gelatin (step S102). The mixture may include from about 10% to about 30% by volume gelatin and from about 70% to about 90% by volume water.

The hydrated gelatin can be produced by common means known in the art. For example, the unhydrated gelatin is stirred as it is poured into the water. Glass containers can be used to mix the gelatin and the water to ensure that no undesired chemical reactions occur.

The mixture is stirred and allowed to hydrate (step S104) at a temperature of approximately 7°-10° Celsius for about 2 to 24 hours. In one embodiment, the mixture hydrates for at least five hours. After the hydration step S104, the mixture is heated (step S106). Heating of the mixture starts when the temperature approximates room temperature, and this heating step S106 continues in increments of 6° C. until the temperature approximates 60° C. The heating step S106 occurs over a period of about 4 hours until the mixture is clear. The heating step S106 can be accomplished by utilization of a hotplate with magnetic stirrers and thermocouples with feedback control (hereinafter referred to as “hotplate”). A temperature of the mixture can be measured at approximately 6.55 mm above the bottom of the container. A thermocouple or a similar temperature measuring device can monitor the mixture's temperature.

The clarity of the mixture indicates that the hydrated gelatin liquefied, and that the gelatin formulation will display no turbidity. It is desirable that the temperature not exceed 71° C. since the gelatin can burn, which can cause the gelatin to otherwise change properties. In one embodiment, the mixture is not heated above 40° C. to ensure accurate ballistic performance.

In one embodiment, the entire heating procedure is achieved below boiling point temperature. The mixture is stirred throughout the heating step S106.

The mixture is optionally poured into a mold or a container (step S108) to form hydrated (ballistic) gelatin. Other suitable methods of forming ballistic gelatin are disclosed in U.S. Publication No. 2006/0191544 to Simmonds, et al. (“the '544 publication”), the disclosure of which is incorporated herein in its entirety by reference.

In an alternative embodiment, prepared ballistic gelatin can be obtained in block form, such as Corbin SIM-TEST™ Ballistic Media, manufactured and distributed by Corbin Manufacturing & Supply, Inc. In this embodiment, steps S102-S108 are omitted.

At 110, the block of ballistic gelatin may be divided into pieces, for example, by cutting the block into a plurality of approximately 2-cm³ cubes.

The cubed ballistic gelatin is weighed out in an amount calculated to equal the desired final volume percent of gelatin (step S112).

In an alternative method, steps S108-S112 are omitted and the liquid hydrated gelatin produced at step S104 or S106 is used in place of the ballistic gelatin.

At 114, the ballistic gelatin or hydrated gelatin mixture is combined with a glycol-containing liquid (“glycol liquid”). The glycol liquid may be pure glycol, or may contain amounts of other ingredients, such as water (e.g., as a commercially available antifreeze, which may be used in its concentrated form, i.e., not prediluted, which generally contains from 80-96% ethylene glycol). Exemplary antifreeze compositions are described, for example, in U.S. Pat. No. 5,741,436, the disclosure of which is incorporated herein in its entirety by reference. The resulting mixture, which includes gelatin and glycol, may be stirred and heated until a homogeneous mixture results (step S116).

The method is not limited to any specific order in which the ingredients are combined or to any manner in which they are heated. In one embodiment, cubes of ballistic gelatin may be microwaved until the gelatin softens. The glycol liquid may then be added to the softened ballistic gelatin cubes. The mixture of softened ballistic gelatin and glycol is removed to a hotplate, where the mixture is heated and stirred for approximately one hour until the ballistic gelatin melts completely and the glycol is well-mixed therein. A double-boiler can also be used to melt the ballistic media. The temperature of the ballistic media/glycol liquid composition is kept below 100° C.

In another embodiment, glycol liquid is placed on a hot plate and heated until the liquid reaches a sufficient temperature for melting the ballistic gelatin. The ballistic gelatin cubes are added and the mixture is stirred as the cubes melt until the mixture becomes homogeneous. The ballistic gelatin melts in a temperature range between 38° C. and 49° C. It is desired that the mixture is not heated to a temperature above 49° C. to ensure that the mixture does not change properties. It is furthermore desired that the mixture is slowly and evenly heated, and that it never comes to a boil to minimize loss of water during the heating step.

In yet another embodiment, the hot plate can be replaced with a heated mixing tank for industrial scale processes. One such mixing melting and heating tank is obtainable, for example, from Sta-Warm Electric Company.

In yet another embodiment, the hydrated mixture produced at step S104 or S106 is combined with the glycol liquid and may be heated, if necessary, and stirred to form a homogeneous mixture.

As will be appreciated, these examples are intended to be merely exemplary of methods for forming a homogeneous liquid mixture containing gelatin, glycol, and water.

The resultant mixture formed in S116 is poured into either a geometric or an organ-shaped mold (step S118) where it cools until it is set. The mixture is introduced to the mold cavity (e.g., of a two or three part mold) slowly, to avoid incorporation of air bubbles. In one embodiment, one or more sensors can be added to the mold so that they set into the mixture (step S120). For example, one or more sensors are inserted into the mold cavity prior to the liquid mixture being poured therein to set.

Optionally, the simulated organ formed by removing the molded gel formulation from the mold is incorporated into a simulated body. For example, at S122 the set simulated organ can be inserted into a simulated skeleton, which is enclosed by simulated muscle tissue. The simulated organ can alternatively or additionally be enclosed by simulated muscle tissue (step S124). Sensors can optionally be inserted into the simulated tissues or on the simulated skeleton (step S126). As will be appreciated, several simulated organs can be formed by the exemplary method using appropriately shaped molds and appropriate, different gelatin:glycol ratios.

While the method and other methods of the disclosure are illustrated as a series of acts or events, it will be appreciated that the various methods of the disclosure are not limited by the illustrated sequence of such acts or events. In this regard, some acts or events may occur in different orders and/or concurrently with other acts or events apart from those illustrated and described herein, in accordance with the disclosure. It is further noted that not all illustrated steps may be required to implement a process in accordance with the present disclosure. The methods of the disclosure, moreover, may be implemented in association with the disclosed formulations as well as with other simulated tissue formulations not illustrated or described, wherein all such alternatives are contemplated as falling within the scope of the disclosure and the appended claims.

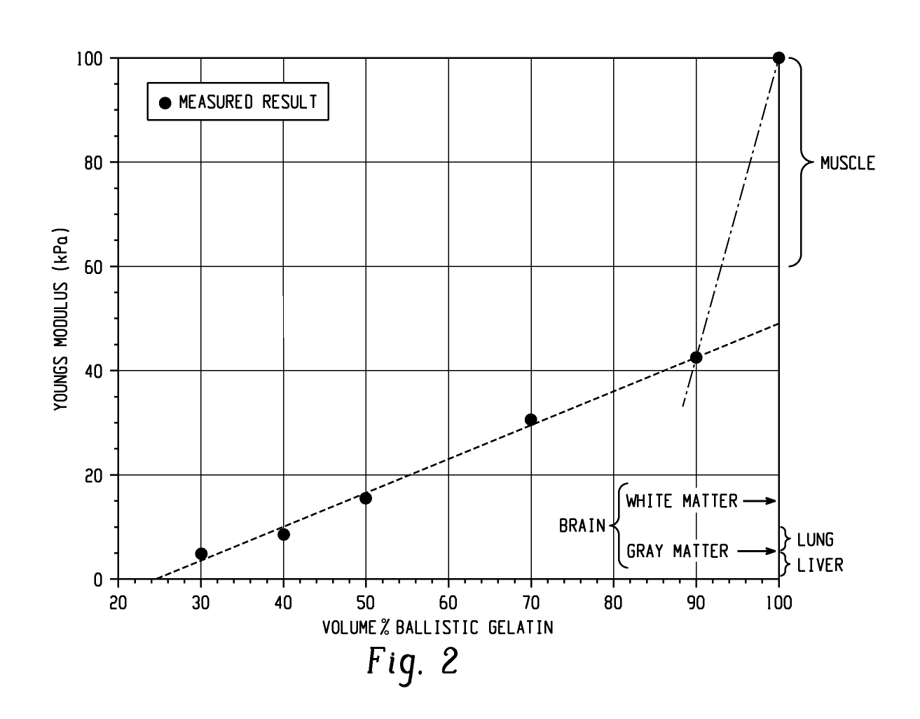

The simulated tissue material for simulated internal organs is created utilizing the general steps of the foregoing method, except that the by volume gelatin and glycol percentages vary for the desired simulated organs. FIG. 2 is a graph which may be used to determine appropriate amounts of ballistic gelatin (approx 20% unhydrated gelatin and 80% water) for exemplary formulations for simulated tissues. In the formulations used to provide the results plotted in FIG. 2, formulations were prepared by heating ballistic gelatin with a glycol liquid (commercial antifreeze) at different ratios and determining the Youngs modulus (kPa) by fitting a linear least-squares line to the initial portion of the measured stress-strain data. The Youngs modulus is thus the slope of this line. The graph also shows Youngs Modulus estimates for known human tissues obtained from the literature (muscle, brain-white matter and gray matter-, lung, and liver). As can be appreciated from FIG. 2, the formulation may be selected to achieve a Youngs modulus within the range of the selected tissue to be simulated.

It is to be noted that the formulation can be prepared using glycol liquid comprised in a commercial antifreeze product. The vol. % glycol and gelatin:glycol ratios disclosed herein are based on calculations utilizing an 80% to 96% by volume ethylene glycol content of commercial antifreeze products. More specifically, the commercial antifreeze product utilized in the following Example section comprises a 92.8 vol % ethylene glycol content. The calculations disclosed herein are based on approximately 90 vol. % glycol content. Hence, this disclosure is not to be limited to only the ranges cited herein. Rather, vol % glycol and gelatin:glycol ratio calculations can vary based on the ethylene glycol content in the commercial antifreeze product used, such as, for example, a concentrated or a prediulted product, etc., if commercial antifreeze is the chosen source of the liquid glycol. New calculations can be expressed for different antifreeze products mixed with ballistic gelatins.

For example, for a simulated brain organ a Youngs modulus in the range of 5-18 KPa is targeted (e.g., a Young's modulus of about 10 KPa). For example, from FIG. 2, it can be seen that a simulated brain can be formed by mixing about 25 vol. % to about 55 vol % ballistic gelatin (or about 4% to about 11% unhydrated gelatin), e.g., about 40 vol. % ballistic gelatin, and from about 10 vol. % to about 75 vol. % glycol liquid (corresponding to about 8 vol. % to about 72 vol. % pure ethylene glycol). Different volume percentages can be utilized for different parts of the brain, such as, for example, the left and right lobes, the cerebellum, the brain stem, the spinal column, etc. The resultant mixture can be set into an anatomically correct mold that can simulate a size and a shape of the brain, and the resultant simulated brain can be enclosed by a simulated skull-like skeleton, a denser, simulated tissue, or both for ballistic wound testing.

A simulated lung(s) organ can be formed by targeting a Young's modulus of about 5-12 Kpa. This can be achieved by mixing about 30-42 vol. % of ballistic gelatin (approx 6 vol. % to 14 vol. % unhydrated gelatin) and from about 58% to 70% glycol liquid (about 46-68 vol. % pure ethylene glycol). The resultant mixture can be cast in an anatomically correct lung-shaped mold so that the simulated lungs have a size, a shape, and general dimensions of a human lung.

A simulated liver organ is formed by targeting a Youngs modulus of 1-5 KPa. This can be achieved by mixing from about 25% to about 32 vol. % ballistic gelatin (about 5-6.5% unhydrated gelatin) about 68% to 75% glycol liquid (about 55% to about 72 vol. % ethylene glycol). The resultant mixture can be cast in an anatomically correct liver-shaped mold so that the simulated liver has a size, a shape, and general dimensions of a human liver.

Other simulated inner organs can similarly be formed by mixing volume percentages that result in a model that provides human tissue properties including, but not limited to, a trachea, an esophagus, a stomach, large and small intestines, kidneys, a pancreas, and a diaphragm.

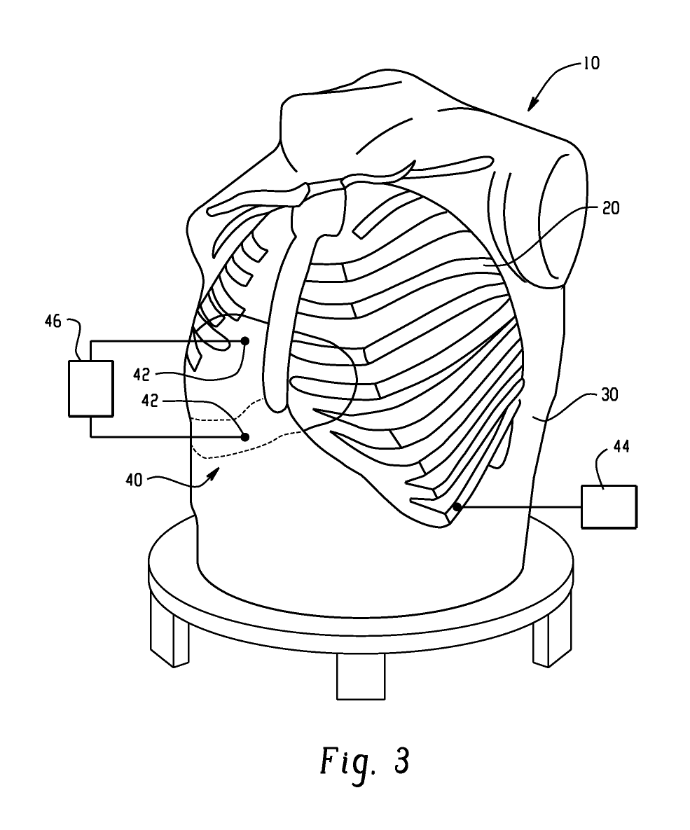

To achieve a human-like response, a simulated anatomic model 10, as shown in FIG. 3, can be constructed. The simulated anatomic model 10 can be formed from a skeletal component or components such as a geometrically realistic simulated spinal and/or rib cage skeleton 20 or an actual skeleton from a human or other animal. A commercially available skeletal system of a thoracic surrogate model, for example, includes a spine, a sternum, and a rib cage, which may be encased by simulated tissue 30 formed of the exemplary gel formulation or an existing material. Additionally, a calvicle, a scapula, and a pelvis may be included. For the ballistic test performed on a brain organ, a cranium surrogate model (not shown) can be utilized for a simulated anatomic model.

The simulated organs 40, of which some or all are formed from the exemplary molded gel formulation, are situated in the surrogate models before they are surrounded by the more dense simulated muscle tissue 30. Optionally, at least one sensing instrument is mounted in the skeletal component and/or simulated organ. For example, at least one pressure sensor 42 and/or at least one three-axis accelerometer 44 can be additionally placed in the anatomic surrogate 10. The sensor 42 measures observed pressure or force as a function of time during impact, which may be related to injury statistics. The sensor and/or accelerometer can be attached to the spine, the sternum, or to other locations on the simulated skeleton 20, or it can be placed within the mold used to set the formulation, which is poured therein the mold so that the set formulation completely surrounds the sensor. Sensors connected to data acquisition channels (not shown) provide a means for measuring acceleration and pressure in response to applied force on the simulated anatomic model 10. The sensor/accelerometer may be connected to an appropriate detector 46 which converts electrical signals into pressure measurements. These measurements can be used to calculate velocity, displacement, and effective (RMS) pressure. Above-mentioned U.S. Publication 2006/0191544, the disclosure of which is incorporated herein by reference in its entirety, discusses placement of the sensors using principal component analysis (“PCA”), which may be utilized in the formation of the exemplary model 10. As will be appreciated, less-complex models of a torso or a head can be made using one or more molded gel formulations and one or more sensors, with or without bone structures.

Without intending to limit the scope of the exemplary embodiment, the following examples demonstrate results which can be obtained using the exemplary molded gel formulations.

### EXAMPLES

Molded gel formulations were prepared by combining ballistic media with glycol liquid at various ratios, as follows:

A 10-lb block of SIM-TEST™ ballistic gel was cut into 2-cm³ cubes. The ballistic gel is stated as having a melting point of 60° C. and a boiling point of 100° C. It is 100% soluble in water. It is stated as having a specific gravity of 1.30±0.2 and a vapor pressure of 760 mm Hg at 100° C. As the glycol liquid, Prestone® Extended Life Antifreeze/Coolant (Concentrated) MSDS501, manufactured by Prestone Products Corporation (Product Number AF2000X; Product UPC Code 7[97496-87157]2), was used. The Prestone® Extended Life Antifreeze/Coolant utilized in the exemplary preparations included about 93% ethylene glycol. The antifreeze is stated as having the following composition: from about 80% by weight to about 95% by weight ethylene glycol, from about 0% by weight to about 5% by weight diethylene glycol, greater than 1% 2-Ethyl Hexanoic Acid, Sodium Salt (i.e., a corrosion inhibitor), and greater than 1% by weight Neodecanoic Acid, Sodium Salt (i.e., a corrosion inhibitor).

Desired volume percentages of ballistic gelatin and glycol liquid were computed in terms of weights of each. The ballistic gelatin cubes for a desired volume percentage were placed in a microwave, which was set to heat them until they begin to melt. The cubes were transferred to a hotplate, where a desired volume percentage of the antifreeze was poured over them.

The ballistic gelatin and the antifreeze were heated and stirred until a homogeneous mixture resulted. The mixture was transferred to a mold, where it set to a desired organ shape.

Molded gel formulations were prepared in this way using the following dilutions:

Formulation A (comparative formulation) contained 100% ballistic gelatin (approximately 20 vol. % gelatin).

Formulation B (exemplary formulation) contained 90% ballistic gelatin, 10% antifreeze (the molded gel formulation thus had an approximate gelatin to ethylene glycol ratio 2.1:1 by volume).

Formulation C (exemplary formulation) contained 70% ballistic gelatin, 30% antifreeze (the molded gel formulation thus had an approximate gelatin to ethylene glycol ratio of 0.55:1, by volume).

Formulation D (exemplary formulation) contained 50% ballistic gelatin, 50% antifreeze (the molded gel formulation thus had an approximate gelatin to ethylene glycol ratio of 0.24:1, by volume).

Formulation E (exemplary formulation) contained 40% ballistic gelatin, 60% antifreeze (the molded gel formulation thus had an approximate gelatin to ethylene glycol ratio of 0.16:1, by volume).

Formulation F (exemplary formulation) contained 30% ballistic gelatin, 70% antifreeze (the molded gel formulation thus had an approximate gelatin to ethylene glycol ratio 0.10:1, by volume).

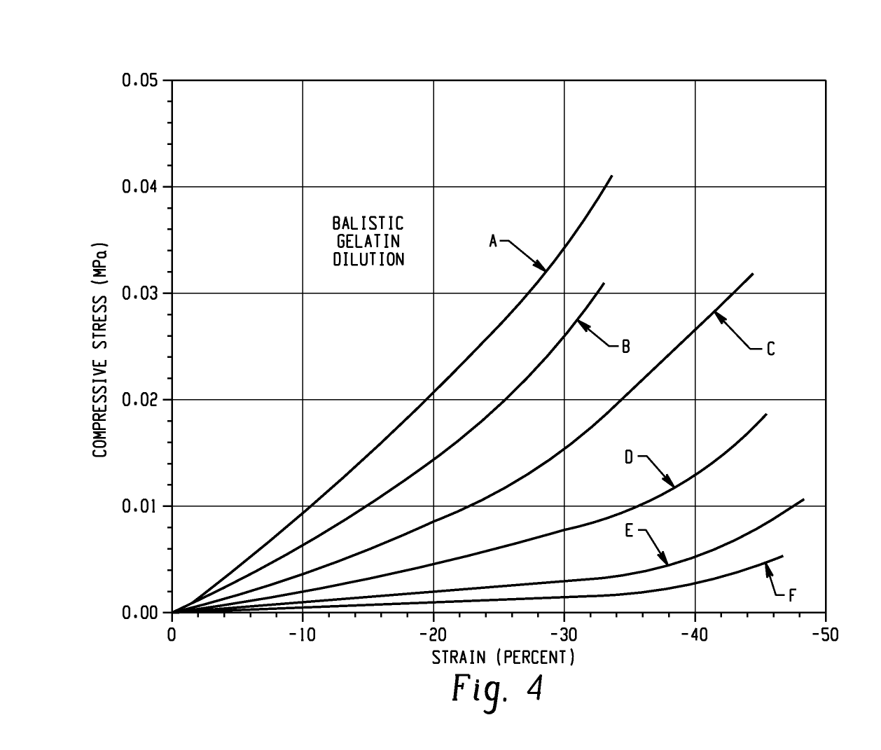

Controlled compression tests were performed utilizing a Dynamic Mechanical Analyzer (“DMA”), in which strain was measured in small, cylindrical specimens subjected to compressive forces applied by metal platens. The stress and strain characteristics of gelatin-based formulations A-F are shown in FIG. 4. The most diluted gelatin formulation, (formulation F), is shown to exhibit the least stress (i.e., compressive force per unit area) and formulation A, the highest for a given strain. Therefore, the formulations that include greater volume percentages of glycol are more flexible than those with lower percentages.

In one embodiment, a cross-linking agent can also be added to the mixture, in which case, a volume percentage of ballistic gel can be decreased for the foregoing volume percentages of glycol to achieve the same strain value.

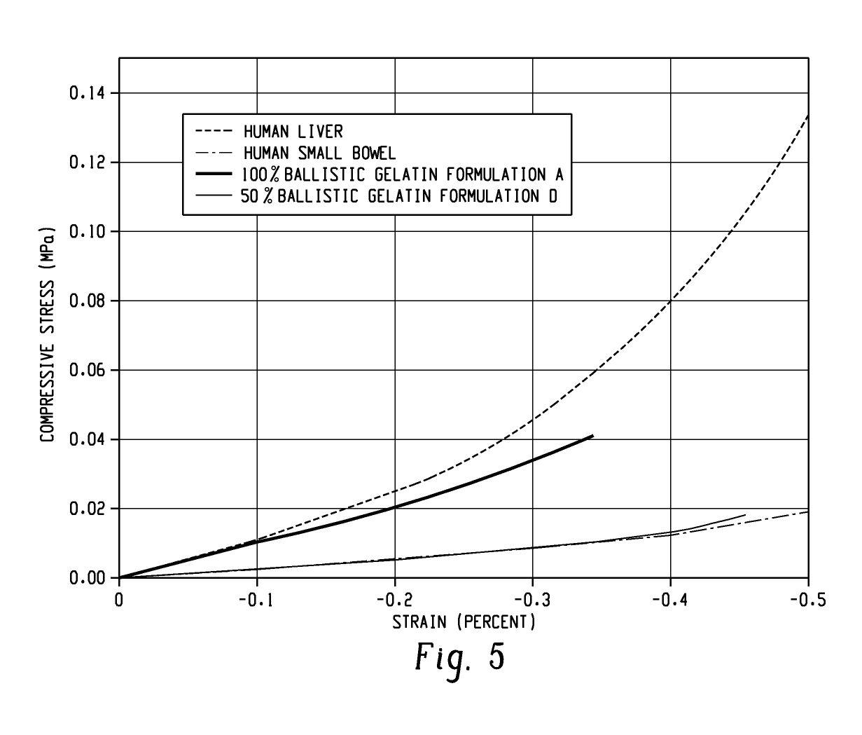

FIG. 5 is a graph showing compressive stress vs. strain relationships for a human liver and a human small bowel (obtained from the literature), a simulated organ of conventional ballistic gelatin (Formulation A), and a simulated organ of the present disclosure (Formulation D). As is shown in the graph, the simulated tissue formulation D of the exemplary embodiment demonstrates good agreement with actual small bowel tissue over the entire range and is similar to liver tissue over at least the first 10% of the strain range. It is concluded that a higher concentration of ballistic gelatin would likely be more appropriate for simulation of the liver tissue.

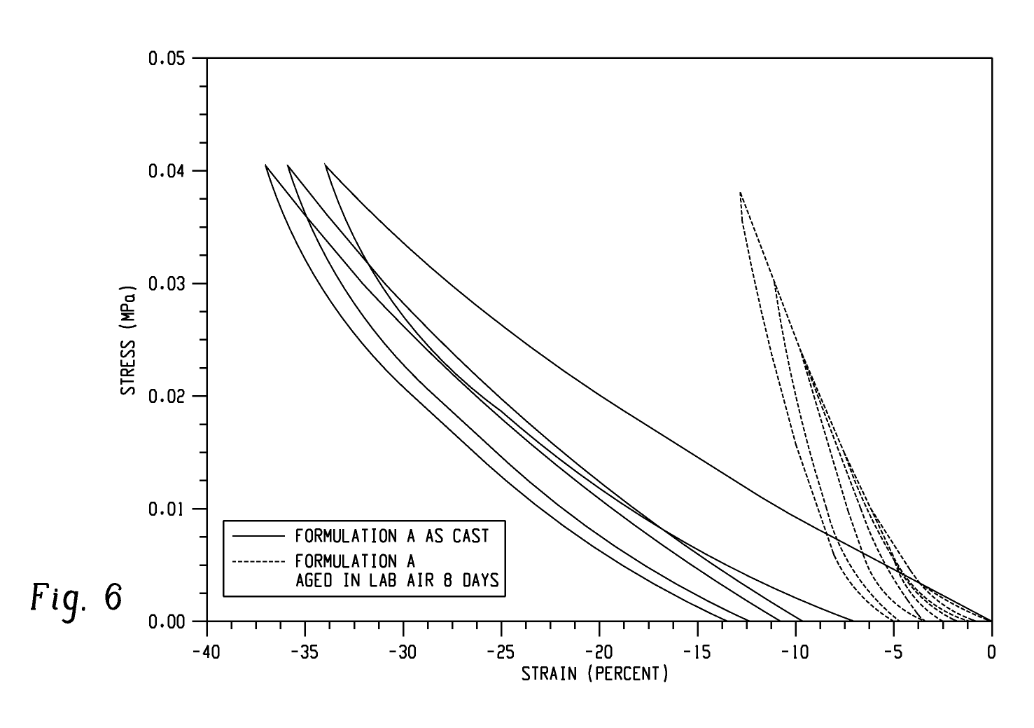

FIGS. 6-11 show compressive mechanical properties for an existing formulation (Formulation A) and formulations presented herein.

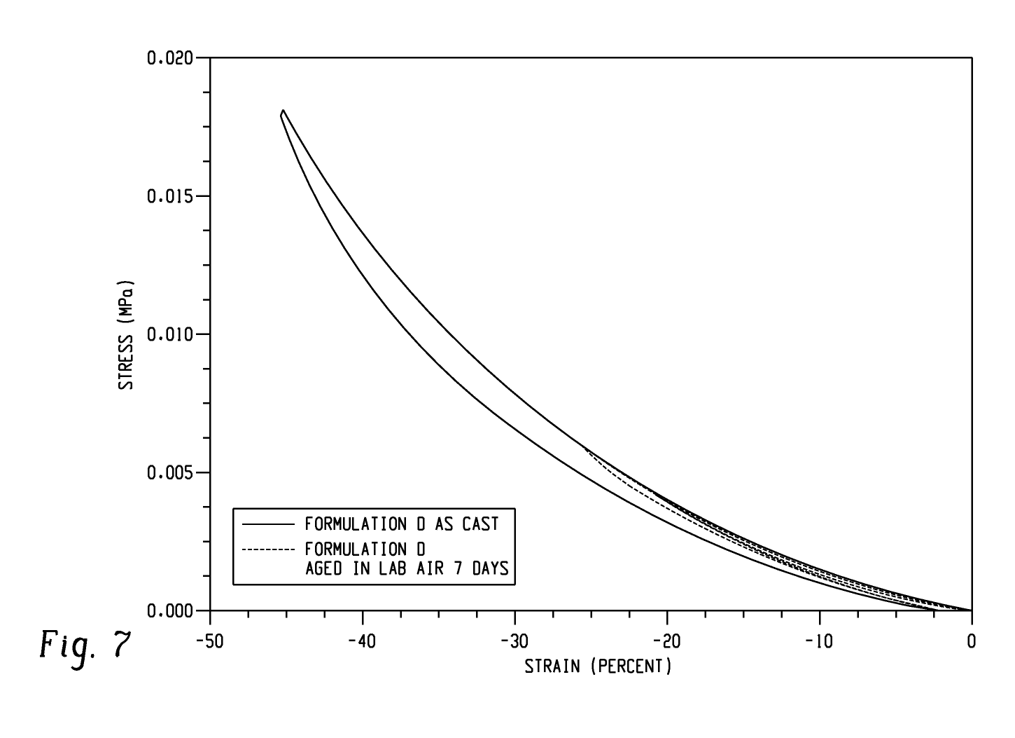

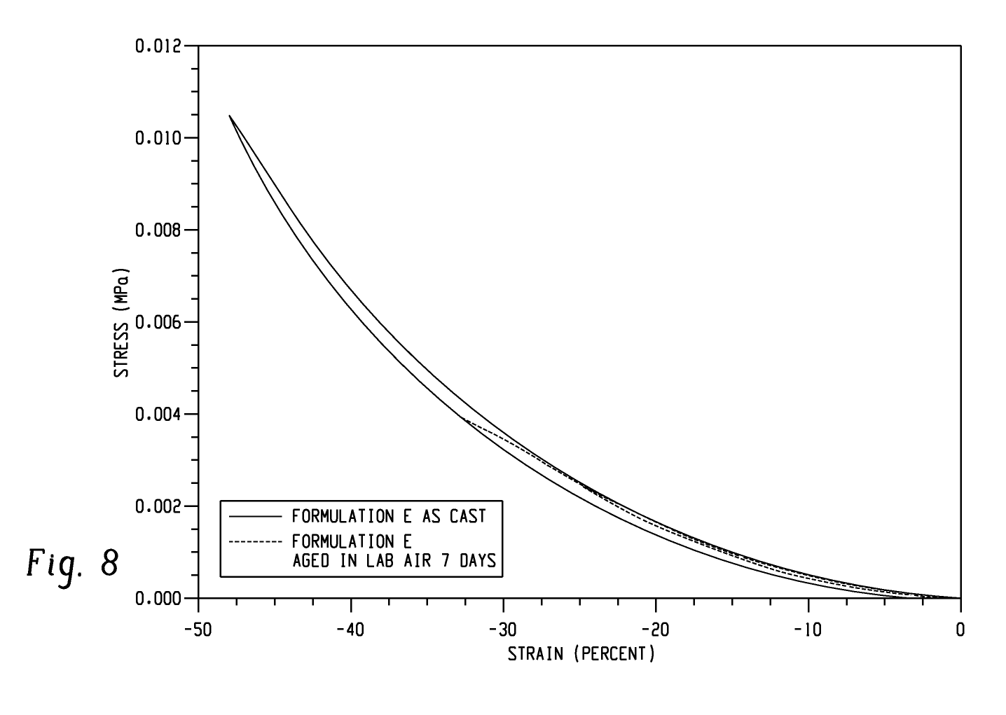

FIGS. 6-8 show the effect of aging in air for formulations A, D, and E, respectively. The results as cast are shown, as well as results obtained after aging in laboratory air for 8 days (FIG. 6) or 7 days (FIGS. 7 and 8).

As is seen from FIG. 6, in the chart, the existing gelatin formulation (Formulation A) exhibits instability over time whereas the exemplary formulations show markedly less instability. It appears that greater volume percentages of glycol tend to cause the most improved stability in the exemplary formulation.

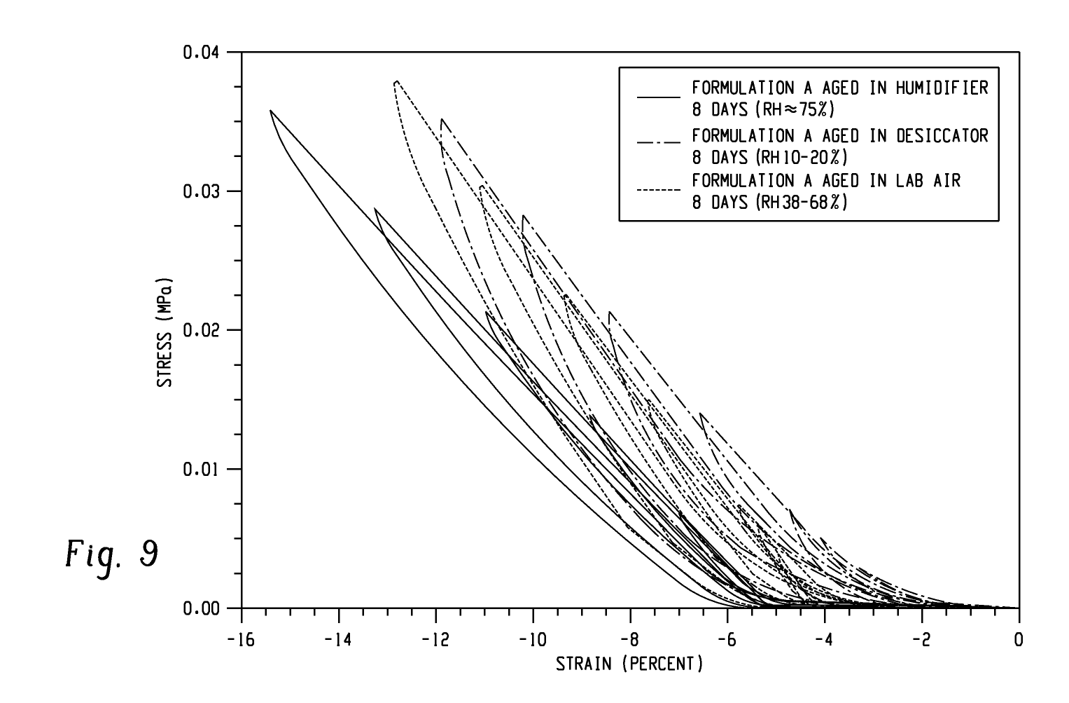

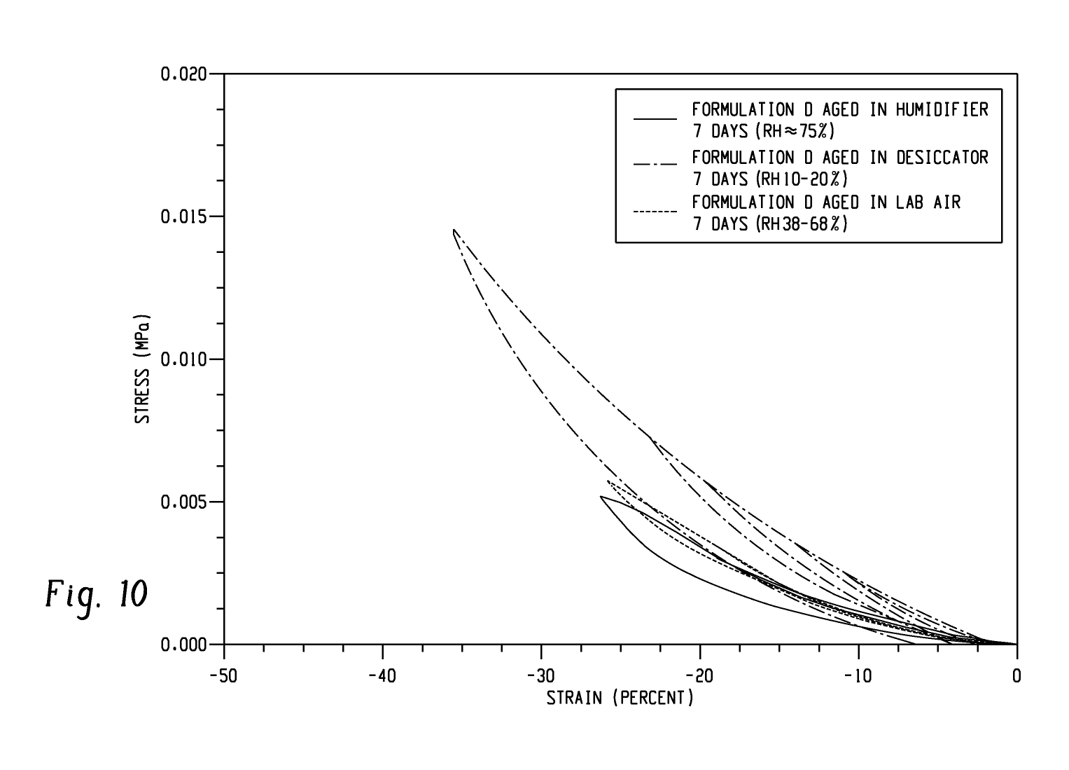

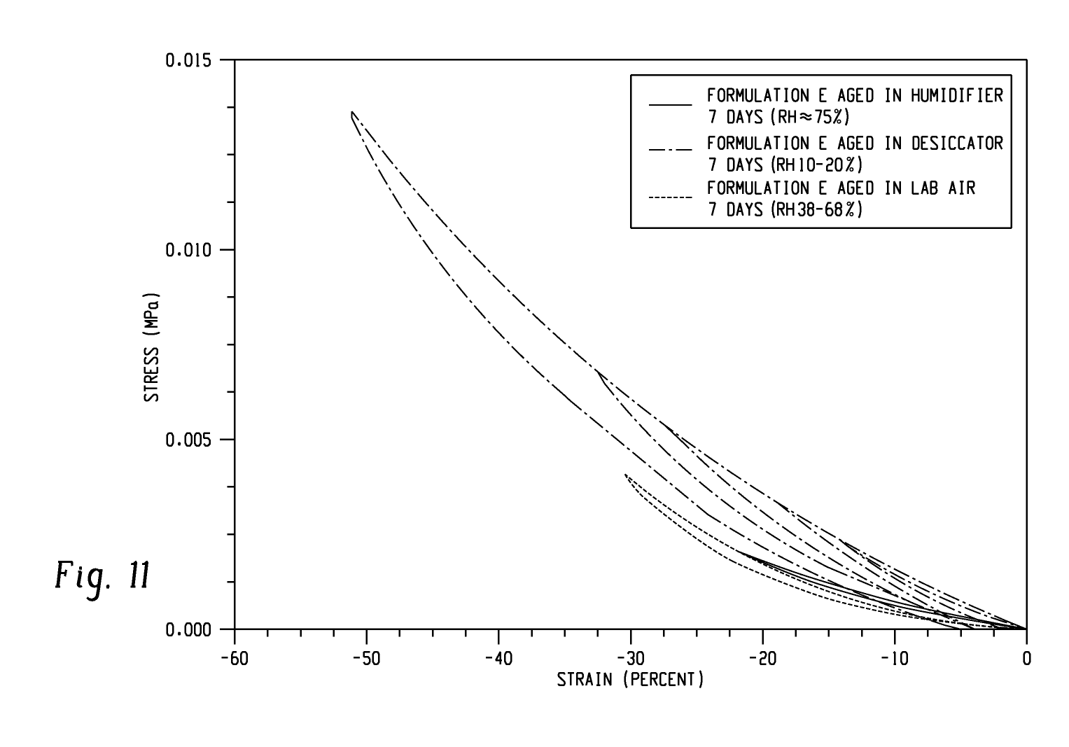

FIG. 9-11 are graphs showing stress and strain relationships for the existing gelatin (Formulation A) and exemplary formulations D and E in various environments after 7 or 8 days of exposure. These environments include a humidifier at 75% relative humidity, laboratory air (38-68% relative humidity), and a desiccator (10-20% relative humidity). As is shown in FIG. 9, the existing gelatin formulation exhibits instability, hardening and stiffening with time when placed in a desiccator where there is little moisture in the air. By comparison, the exemplary formulations D and E in FIGS. 10 and 11 are shown to fare well when placed in a desiccator. They also show less variation between the results in a dessicator and those in humidified or laboratory environments than the existing formulation. Both FIGS. 10 and 11 show that the exemplary formulations have improved stability in all environments.

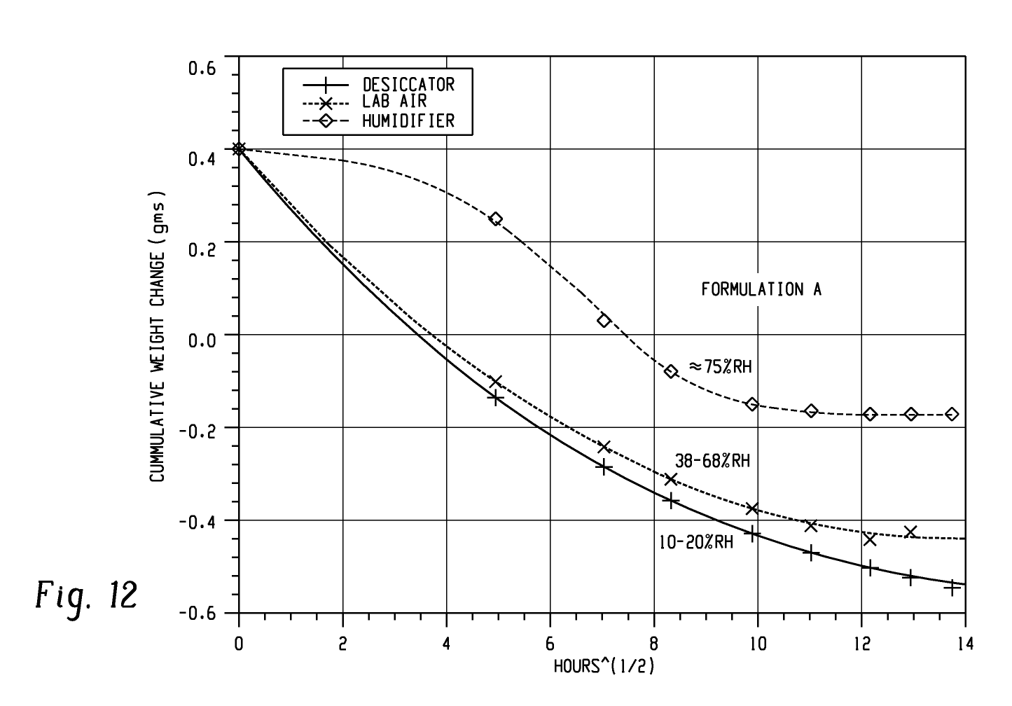

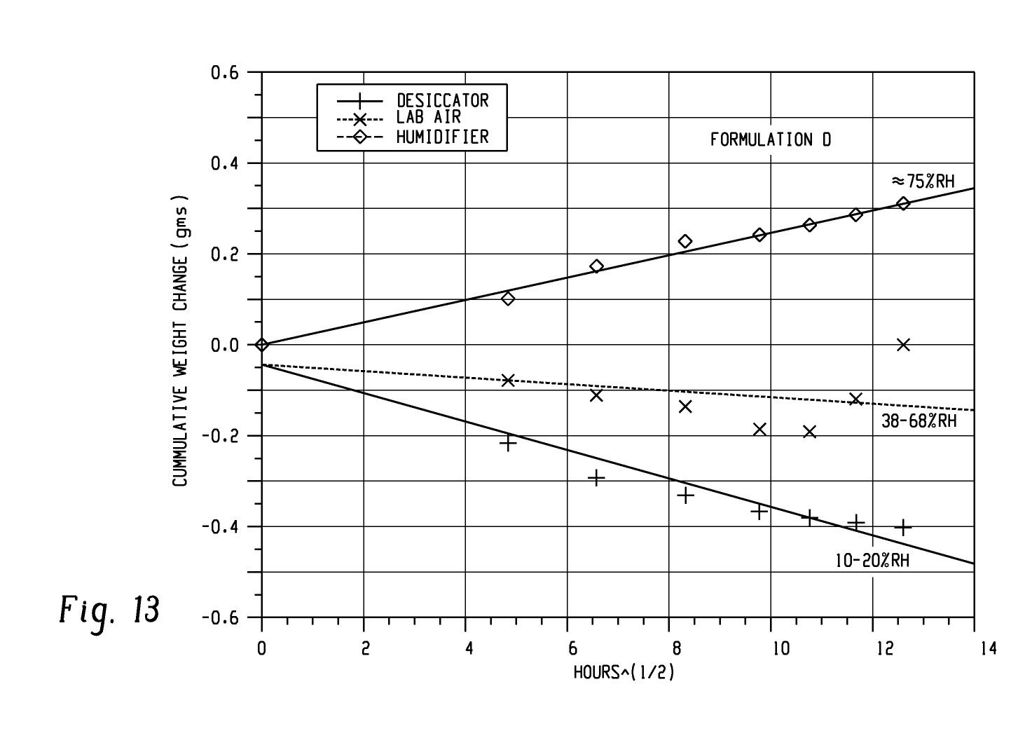

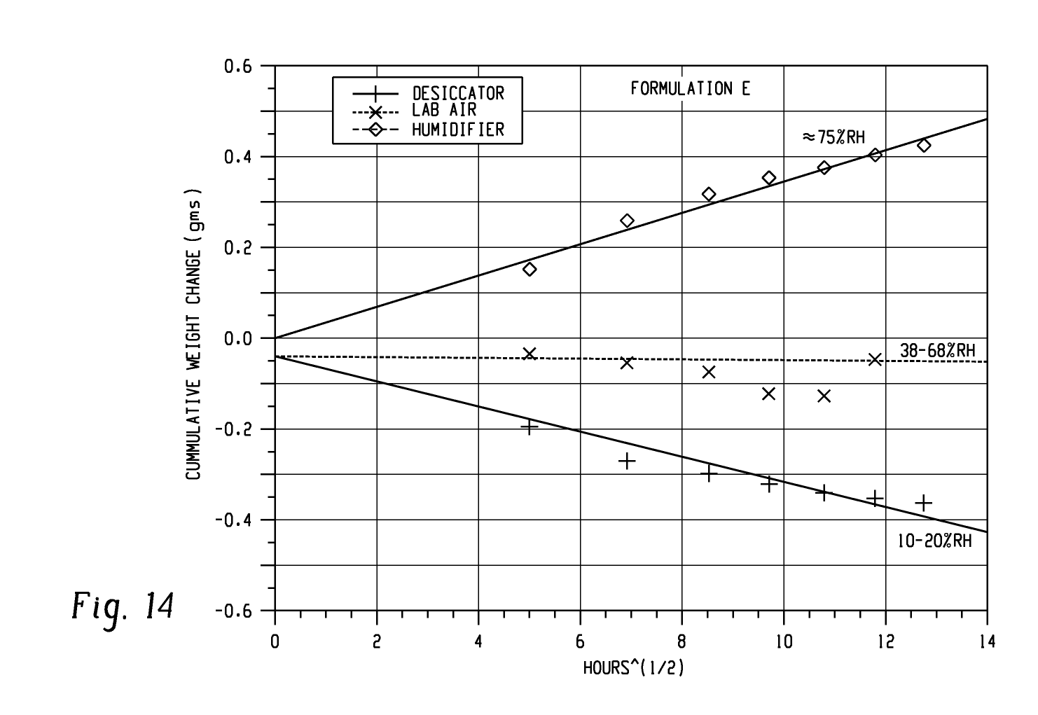

FIGS. 12 to 14 show plots of cumulative weight changes over time, dependent on various environments for formulations A, D, and E, respectively. FIG. 12 shows that the existing ballistic gelatin (Formulation A) loses weight over time, even in conditions of high humidity. By comparison exemplary formulations D and E (FIGS. 13 and 14) only exhibit a significant weight loss in very dry environments (not normally used for ballistic testing) and can gain weight when placed in high relative humidity conditions. Laboratory air testing suggests that after weight loss, the exemplary formulations can regain weight, thus mitigating the earlier changes. These FIGURES show that the exemplary formulations exhibit a very slight or no decrease in weight over time in laboratory environments, which are more representative of those used for ballistics testing and storing of materials.

The comparative results show that an addition of ethylene glycol to gelatin formulations extends the shelf life of resultant simulated tissue as the glycol acts as a water retaining agent. The present formulation for simulated tissue provides a method for forming simulated tissue by simple dilution of ballistic gelatin with a glycol liquid without making it susceptible to drying out and altered mechanical properties.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1-13. (canceled)

14. An anatomic model, comprising:
a skeletal component;
at least one simulated organ supported on or within said skeletal component, said at least one simulated organ comprising the molded formulation of at least 2 vol. % gelatin, at least 5 vol. % of a glycol, and water; and
optionally, at least one sensing instrument in at least one of said simulated skeletal component and said simulated organ.

15. The anatomic model of claim 14, further comprising, simulated muscle tissue surrounding said simulated skeletal components.

16. The anatomic model of claim 14, wherein said simulated muscle tissue comprises 10% to 30% by volume gelatin and from 70% to 90% by volume water.

17. A method of making a simulated human tissue, comprising:
forming a liquid mixture comprising gelatin, a glycol and water; and
setting the mixture to form a molded gel formulation with a shape which simulates a human tissue.

18. The method of claim 17, wherein the forming of the mixture includes combining the glycol with a hydrated gelatin which includes at least some of the water.

19. The method of claim 18, wherein the hydrated gelatin comprises at least 70 vol. % water.

20. The method of claim 17, wherein the method further includes:
forming a first simulated tissue having a first gelatin:glycol ratio; and
forming a second simulated tissue having a second gelatin:glycol ratio higher than the first ratio.

21. The method of claim 20, wherein the first ratio is at least 0.1:1 and the second ratio is at least 0.15:1.

22. The method of claim 17, wherein the glycol is in a liquid composition which includes at least one of water and diethylene glycol.

23. The method of claim 17, wherein the combining includes at least one of:
(a) combining 68% to 75% by volume glycol with said hydrated gelatin and setting said resulting formulation to simulate a human liver;
(b) combining from 58% to 70% by volume glycol with said hydrated gelatin and setting said resulting formulation to simulate a human lung; and
(c) combining from about 8% to about 72% by volume glycol; and setting said resulting formulation to simulate a human brain.

24. The method of claim 17, further comprising placing sensors within said mixture as it sets.

25. The method of claim 17, further comprising at least one of:
(a) enclosing said simulated tissue with simulated muscle tissue;
(b) surrounding said simulated tissue with a skeletal component; and
(c) enclosing said simulated tissue and said simulated skeletal component with simulated muscle tissue.
